(19) United States
(12) Patent Application Publication
(10) Pub. No.: US 2008/0110866 A1
(43) Pub. Date: May 15, 2008

(54) Shield for Resistance Welding Gun

(75) Inventors: Javier Chirivella, Valencia (ES); Juan Martinez Collado, Valencia (ES); Iv Contreras N, Valencia (ES); Francisco Cantador, Valencia (ES); Vicente Galdon, Valencia (ES); Juan Jose Puig Rosell, Valencia (ES); Miguel Viana Espi, Valencia (ES); Gines Cano Paton, Valencia (ES)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/559,617

(22) Filed: Nov. 14, 2006

(51) Int. Cl. B23K 11/36

(52) U.S. Cl. 219/78.01

(57) ABSTRACT

A shield for a resistance welding tool is disclosed that is formed in a generally tubular bellows-like configuration. The shield is flexible so that it may be compressed upon engagement with an object to be welded and thereby shield the area around one side of the object to be welded. The shield includes a neck that is secured to one of the weld tips and a mouth that engages the object to be welded. An undulating wall is provided between the neck and the mouth of the shield.

### BACKGROUND OF THE INVENTION

1. Field of the Invention

The present invention relates to a shield for a resistance welding gun that minimizes weld splatter being deposited on an object to be welded.

2. Background Art

Resistance welding guns are used to weld metal assemblies, such as vehicle bodies. Resistance welding guns generally have a primary weld tip and a back-up weld tip that engage a workpiece from opposite sides. Weld splatter may occur during a resistance welding operation and may be seen as sparks or flash that emanate from the weld. On interior panels or structural braces a limited amount of weld spatter does not create a problem. However, welds made near exterior surfaces of a product may result in rejected parts and repair expenses to remove the weld splatter from the outer, or Class-A surface of the object to be welded. For example, door openings in vehicles normally require a large number of welds that are immediately adjacent class A surfaces comprising the outer panels of the vehicle. Weld splatter deposited on the outer surface must either be removed in a grinding or buffing operation prior to painting.

Weld splatter may be caused by a wide variety of problems. If parts do not match up exactly or if the welding parameters are not closely controlled, weld splatter can be created. Other sources of weld splatter may include poorly dressed tips for the welding guns or worn welding caps. Weld splatter can also be caused if the weld gun does not align itself perpendicularly relative to the surfaces of the sheet metal pieces to be welded together. Weld splatter can also be caused by dirt or other contaminants on either the sheet metal surfaces or the tips of the weld gun. With so many different potential sources of weld splatter, there is only so much that can be done to eliminate weld splatter.

There is a need for a shield that prevents weld splatter from resistance welding guns from being deposited on critical surfaces of an object to be welded. Further, any such shield must be simple to use and inexpensive. An acceptable shield should not interfere with tip dressing procedures or cause any damage such as denting or scratching the surface of the workpiece to be welded. The above problems are addressed by Applicants' invention as summarized below.

### SUMMARY OF THE INVENTION

According to one aspect of the present invention, a resistance welding machine is provided that comprises a welding gun having a shield. The welding gun may be a resistance welding gun having a primary weld tip and a back-up weld tip. The shield is formed in a tubular configuration that is assembled to one of the weld tips. The shield engages one side of an object to be welded prior to engagement of the object to be welded by the weld tips. The shield is compressed upon engagement with the object to be welded to shield the area around one side of the object to be welded. The shield prevents the deposit of weld splatter on the object to be welded outside of the shield.

According to another aspect of the present invention, a shield for a resistance welding tool having a primary weld tip and a back-up weld tip is provided. The shield includes a neck that is elastically attached to the primary welding tip. A bellows wall extends along the primary weld tip toward a distal end of the weld tip. A mouth is formed on the opposite end of the bellows wall from the neck that is initially disposed beyond the distal end of the primary weld tip. The bellows wall is compressed and the mouth is shifted toward the distal end of the primary weld tip when the resistance welding tool engages an object to be welded.

According to other aspects of the inventions referred to above, the shield may be formed of a flexible material that is configured in a hollow bellows shape with an undulating wall having a cylindrical cross-section. The shield may be formed of a knit carbon fiber material. The knit carbon fiber material may be coated with silicone or covered by an aramide cloth. The shield may have a neck that is secured to one of the weld tips adjacent the tip retainer and a distal mouth that engages the object to be welded. The undulating wall of the shield may be disposed between the neck and the mouth of the shield. The shield may be attached to either the primary or back-up weld tip, but is preferably attached to the primary weld tip.

These and other aspects of the present invention will be better understood in view of the attached drawings and following detailed description of the illustrated embodiment.

### BRIEF DESCRIPTION OF THE DRAWINGS

FIG. 1 is a fragmentary exploded perspective view of a weld gun shown with a shield and a workpiece;

FIG. 2 is a partially cross sectional view of the weld gun with the shield prior to engagement with the workpiece; and

FIG. 3 is a partial cross sectional view of a weld gun end shield engaging a workpiece to prevent weld splatter from being deposited outside of the shield.

### DETAILED DESCRIPTION OF THE PREFERRED EMBODIMENT(S)

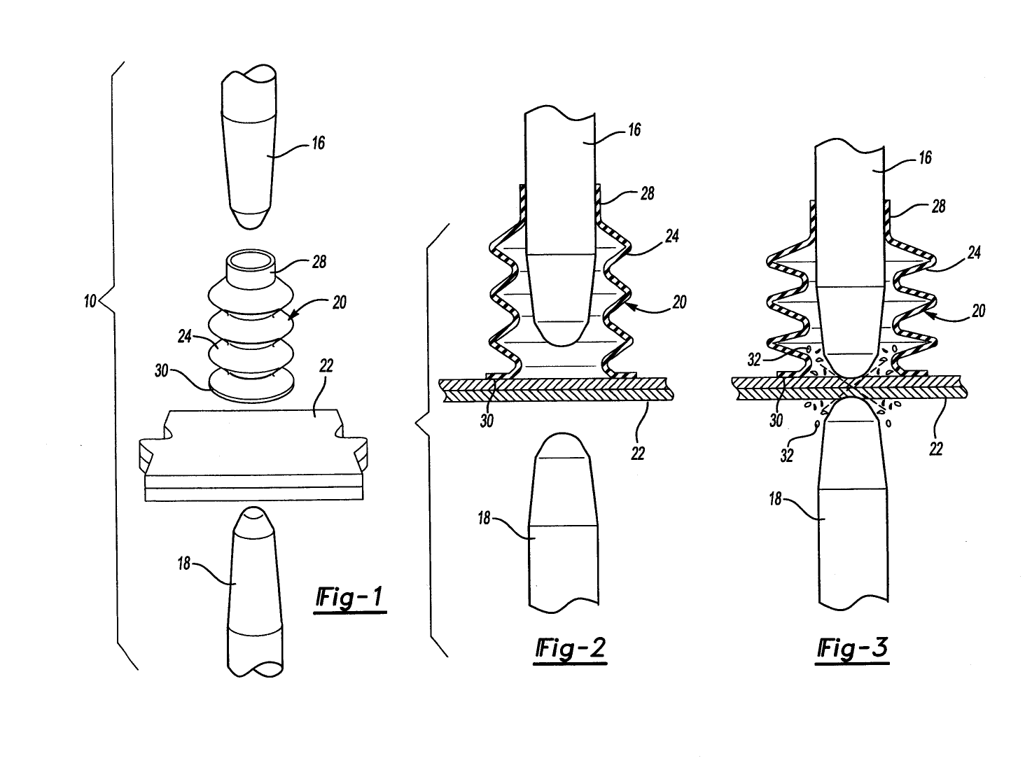

Referring to FIG. 1, part of a welding gun 10 is shown. A primary weld tip 16 is shown with a back-up weld tip 18. A shield 20 is shown disassembled from the primary weld tip 16. The shield 20 is used to shield a workpiece 22, or object to be welded.

The shield 20 has a bellows wall 24 that extends between a neck portion 28 or retaining band, and a mouth portion 30. The bellows wall 24 is an undulating wall formed by oppositely oriented conical segments.

As shown in FIG. 2, the primary weld tip 16 and back-up weld tip 18 are shown just prior to initiating a welding operation on the workpiece 22. The shield 20 is shown secured to the primary weld tip 16 and in engagement with the workpiece 22. The mouth 30 of the shield 20 engages one side of the workpiece 22. The neck 28 of the shield 20 exerts a compressive force on the primary weld tip 16 to hold the shield 20 in place as it engages the workpiece 22.

Referring to FIG. 3, the primary weld tip 16 and back-up weld tip 18 are shown engaging opposite sides of the workpiece 22 to perform a welding operation on the workpiece 22. The shield 20 has been compressed with the mouth 30 having been moved back towards the neck 28 compressing the bellows wall 24. Weld spatter 32 is shown emanating from the primary weld tip 16 and back-up weld tip 18. The shield 20 serves to confine the weld spatter 32 emanating from the primary weld tip 16. The shield prevents the weld splatter from being projected outside of the shield 20 and onto finished external surfaces of the workpiece 22. The bellows may be made of Kevlar™ covered by silicone but also made be made of a knit Kevlar™ material that is covered by an aramide cloth called Preox™.

While the best mode for carrying out the invention has been described in detail, those familiar with the art to which this invention relates will recognize various alternative designs and embodiments for practicing the invention as defined by the following claims.

What is claimed:

1. A resistance welding machine comprising:
a resistance weld gun having a primary weld tip and a back-up weld tip;
a shield formed in a tubular configuration, the shield being assembled to one of the weld tips; and
wherein the shield engages one side of an object to be welded prior to engagement of the object to be welded by the weld tips, and wherein the shield is compressed upon engagement with the object to be welded to shield the area around the one side of the object to be welded to prevent the deposit of weld splatter outside of the shield on the object to be welded.

2. The resistance welding machine of claim 1 wherein the shield is formed of a flexible material and is configured in a hollow bellows shape with an undulating wall having a cylindrical cross-section.

3. The resistance welding machine of claim 1 wherein the shield is formed of knit carbon fiber material.

4. The resistance welding machine of claim 3 wherein the shield is covered by an aramide cloth.

5. The resistance welding machine of claim 3 wherein the knit carbon fiber material is coated with a silicone material.

6. The resistance welding machine of claim 1 wherein the shield has a neck that is secured to the one of the weld tips adjacent a tip retainer, and a distal mouth that engages the object to be welded.

7. The resistance welding machine of claim 6 wherein an undulating wall of the shield is disposed between the neck and the mouth of the shield.

8. The resistance welding machine of claim 1 wherein the shield is attached to the primary weld tip.

9. A shield for a resistance welding tool having a primary weld tip and a back-up weld tip comprising:
a retaining band that is elastically attached to the primary weld tip;
a bellows wall extending along the primary weld tip toward a distal end of the weld tip;
a mouth on the opposite end of the bellows wall from the retaining band that is initially disposed beyond the distal end of the primary weld tip; and
wherein the bellows wall is compressed and the mouth is shifted toward the distal end of the primary weld tip when the resistance welding tool engages an object to be welded.

10. The shield of claim 9 wherein the retaining band, bellows wall, and mouth are integrally formed of a flexible material.

11. The shield of claim 9 wherein the shield is formed of knit carbon fiber material.

12. The shield of claim 9 wherein the shield is covered by an aramide cloth.

13. The shield of claim 9 wherein the knit carbon fiber material is coated with a silicone material.

14. The shield of claim 9 wherein the retaining band is secured to the primary weld tip adjacent a tip retainer.

15. The shield of claim 14 wherein the bellows wall of the shield is disposed between the retaining band and the mouth of the shield.
